(19) United States
(12) Patent Application Publication
(10) Pub. No.: US 2024/0064268 A1
(43) Pub. Date: Feb. 22, 2024

(54) SYSTEMS AND METHODS FOR NETWORK-CONNECTED IMAGE AND VIDEO CAPTURE

(71) Applicant: No On Ion LLC, Englewood, NJ (US)

(72) Inventor: David Tobias, Englewood, NJ (US)

(21) Appl. No.: 18/271,739

(22) PCT Filed: Jan. 24, 2022
(86) PCT No.: PCT/US22/13580

§ 371 Date: Jul. 11, 2023

Related U.S. Application Data
(60) Provisional application No. 63/140,275, filed on Jan. 22, 2021.

(51) Int. Cl. H04N 5/77; H04N 7/18; H04N 5/262; H04N 1/00; H04W 12/08; G06F 21/62

(52) U.S. Cl. CPC H04N 5/77; H04N 7/181; H04N 5/2624; H04N 1/00244; H04W 12/08; G06F 21/6218; H04N 23/667

(57) ABSTRACT

A small, portable digital camera captures and shares still images and video. The camera is wirelessly integrated with cloud services to share the captured media via website, mobile device app and other services. The device is inexpensive and can be connected to share media via cellular, Wi-Fi, and Bluetooth. Preferred versions are compact enough to fit on a keychain or in a pocket, and inexpensive enough to lose or break without major concern. Multiple devices can be linked together to contribute to a common media archive and account for a party, wedding, political rally, or other event.

This application claims the benefit of U.S. Provisional Application Ser. No. 63/140,275 filed Jan. 22, 2021, titled “Small, Inexpensive Cloud-Based Connected Image and Video Capture Device,” the entire contents of which are incorporated herein by reference.

### TECHNICAL FIELD

This invention relates to camera devices that capture images and video and to systems and methods for transmitting captured media from the camera devices via a network to a storage location.

### BACKGROUND ART

There are a wide variety of digital cameras available, ranging from more complex Digital Single Lens Reflex (DSLR) cameras to cameras built into cellphones and other devices. Many DSLRs have wireless communications capability and can transmit digital images or video through a network. Cellphone camera images and videos can typically be transmitted via a wifi or cellular network to another location.

However, standalone cameras such as DSLRs are typically expensive and delicate, requiring careful handling. Cellphones are also expensive devices that are easily damaged. Both DSLRs and cellphones have minimum design sizes below which they would lose expected functionality.

The inventor has determined that there is a need for improved systems and methods in the field of media capture and uploading devices and systems. Devices that are smaller and less expensive than either standalone cameras or cellphones would offer a significant advantage. The inventor has also identified advantages that can be achieved by developing improved systems and methods for transmitting and collecting media information, such as in cloud storage.

### BRIEF SUMMARY OF THE INVENTION

In an example embodiment, a compact, portable digital camera captures and shares still images and video. The camera is wirelessly integrated with cloud services for sharing the captured media via website, mobile device app and other services. The device is inexpensive and can be connected to share media via cellular, Wi-Fi, and Bluetooth. In preferred embodiments, the device is compact enough to fit on a keychain or in a pocket, and inexpensive enough to lose or break without major concern. In a further embodiment, multiple devices can be linked together and contribute to a common media archive and account.

The disclosed systems and methods provide a variety of significant unobvious advantages. Using these systems and methods, users are provided with a more focused, efficient, media capture device than a mobile phone and a more accessible and connected device than a typical digital camera. For groups, this is an extremely easy way to capture media together as technical specifications of the content captured match and the ubiquity and simplicity of the user experience is very easy to understand and operate. For children and technology-averse the device offers a secure way to capture media files (including image, videos, and/or audio) and share with family and friends.

### BRIEF DESCRIPTION OF THE DRAWINGS

The accompanying drawings, which are incorporated herein and form a part of the specification, illustrate various exemplary embodiments of the present invention and, together with the description, further serve to explain various principles and to enable a person skilled in the pertinent art to make and use the invention. In the drawings, like reference numerals may be used to designate like parts.

FIG. 1a is an exploded assembly view of an electronic device for capturing images and video, seen from the top.

FIG. 1b is an exploded assembly view of an electronic device for capturing images and video, seen from the bottom.

FIG. 2 is a block schematic circuit diagram of an example embodiment of an image and video capture device.

FIG. 3a is a diagram showing an example embodiment of a process for collecting images and videos and transmitting them to storage via an NB-IoT network.

FIG. 3b is a diagram showing an example embodiment of a process for collecting images and videos and transmitting them to storage via a satellite network.

FIG. 4 is an example of an internet browser screen display for accessing media previously transmitted to cloud storage.

FIG. 5 is a diagram showing an embodiment in which a plurality of camera devices are deployed to wirelessly transmit media files and aggregate them in a single cloud storage account.

FIG. 6 shows an example embodiment in which a plurality of camera devices are configured to wirelessly relay media files from devices with poor connections to aggregate the media files in a single cloud storage account.

FIG. 7 is a diagram illustrating an exemplary method for collecting a plurality of images using one or more devices in a defined area, and generating an interior photo mapping of the area.

FIG. 8 illustrates an example embodiment of a user input and control mechanism for a digital media file capture device.

FIG. 9 is a diagram showing how joystick movement patterns are used in one embodiment, to lock and/or unlock the device for use.

FIG. 10a shows an example embodiment of a seedpod mounted to a circuit board.

FIG. 10b illlustrates moisture reaching the seedpod of FIG. 10a and causing germination of the seed.

FIG. 10c illustrates the growth of a plant from the seedpod of FIGS. 10a and 10b.

### BEST MODE FOR CARRYING OUT THE INVENTION

The present invention will be described in terms of one or more examples, with reference to the accompanying drawings.

The present invention will also be explained in terms of exemplary embodiments. This specification discloses one or more embodiments that incorporate the features of this invention. The disclosure herein will provide examples of embodiments, including examples from which those skilled in the art will appreciate various novel approaches and features developed by the inventors. These various novel approaches and features, as they may appear herein, may be used individually, or in combination with each other as desired.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, persons skilled in the art may implement such feature, structure, or characteristic in connection with other embodiments whether or not explicitly described.

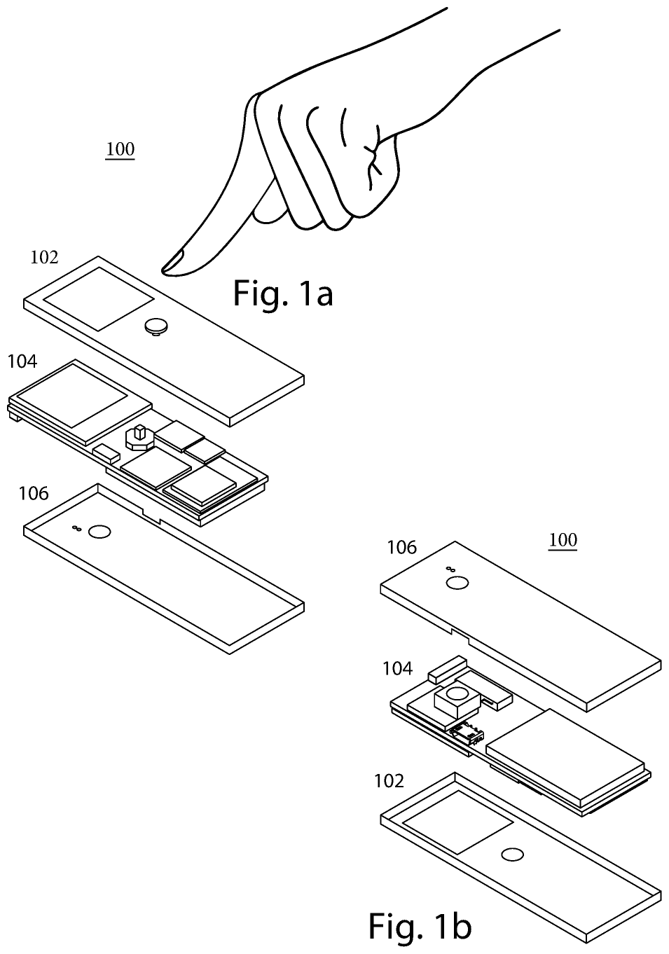

FIGS. 1a and 1b are exploded assembly views of an example embodiment of an electronic device for capturing images and video. In the example shown, a printed circuit board 104 is assembled between upper housing 102 and lower housing 106. In this embodiment, the housing components have a width of approximately 27 mm and a length of approximately 75 mm. FIG. 1a shows a top view of each of components 102, 104 and 106, while FIG. 1b shows a bottom view. The housing also preferably includes a lanyard loop (not shown in FIGS. 1a and 1b).

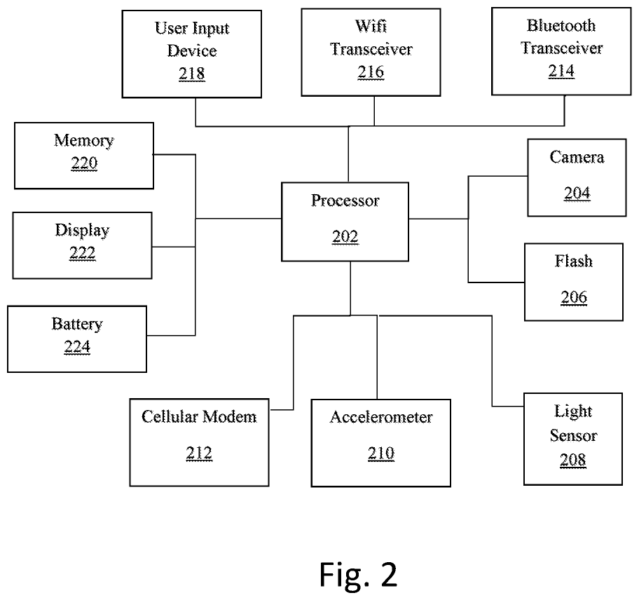

FIG. 2 is a block schematic diagram of an embodiment of printed circuit board 104. In this embodiment, printed circuit board 104 comprises a processor 202, connected to each of: a camera 204, a flash 206, an ambient lowlight sensor 208, an accelerometer 210, a cellular modem 212 (which is preferably a narrowband Internet of Things (IoT) modem but may also be a full broadband cellular data interface), a Bluetooth transceiver 214, a Wi-Fi transceiver 216, a user input device 218, flash memory storage 220, and a display device such as liquid crystal display 222. These circuits are each connected to and powered by a rechargeable battery 224; the connections of battery 224 to each powered element are omitted from the drawing figure for clarity. Cellular modem 212, Bluetooth transceiver 214, and Wi-Fi transceiver 216 each include an appropriate antenna to support transmission and reception of data. Camera 204 comprises a digital image sensor and associated circuits.

Optional components and features (not shown) are included in some embodiments. Optional components may include, for example, a swiveling screen for more accurate selfie mode, magnets mounted internally in the device to trigger different modes upon accessory activation, attachment points for accessories such as keychains and lanyards, and providing a moldable, putty-like body for manipulation by the user to adapt to different functions needed. For example, the case could be molded by the user into a shape that functions as a stand or grip.

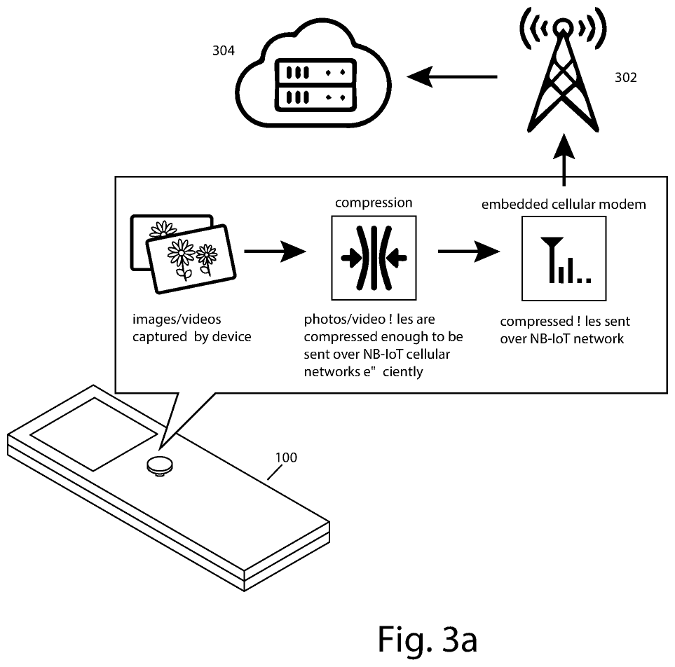

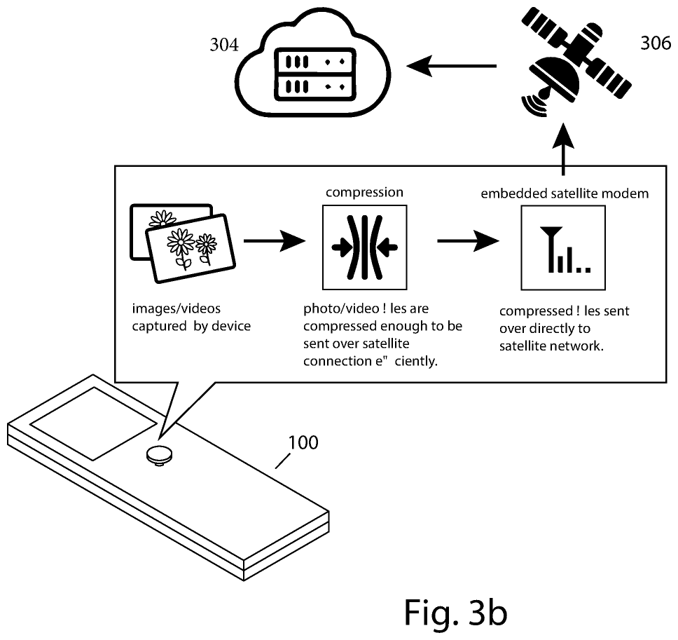

FIGS. 3a and 3b illustrate example wireless connections and processing methods to connect device 100 to a media storage (cloud storage) server 304. In the preferred embodiment shown in FIG. 3a, device 100 is operably connected to transmit media files via a narrowband IoT cellular network (NB-IoT) 302. This feature is novel; NB-IoT is typically reserved for devices that require low power and transmit only small amounts of data. A conventional mobile media sharing device would not use NB-IoT network 302. In this embodiment, device 100 implements a data compression process in which the size of media files is significantly reduced.

In various embodiments, device 100 may be adapted to capture and transmit image files, video files, and/or audio files (collectively referred to herein as media files).

The inventor has determined that if media files are first compressed in this manner (for example, reducing size to below 1 MB), then contrary to conventional wisdom, device 100 can use NB-IoT network 302 to upload media files. This approach provides several advantages. The device can operate with extremely low power consumption when processing/uploading, can employ a smaller NB-IoT modem/antenna, allowing reduction in the overall size of the device, and reducing processing demands other than for the compression process. The result is a device that provides more efficient operation, with a lower cost and lower power use.

In another embodiment, illustrated in FIG. 3b, device 100 may employ a satellite network 306. In this embodiment a satellite modem in the device provides a direct connection to satellite network 306. As in the embodiment of FIG. 3b, the media data is compression before transmission to media storage server 304 over satellite network 306.

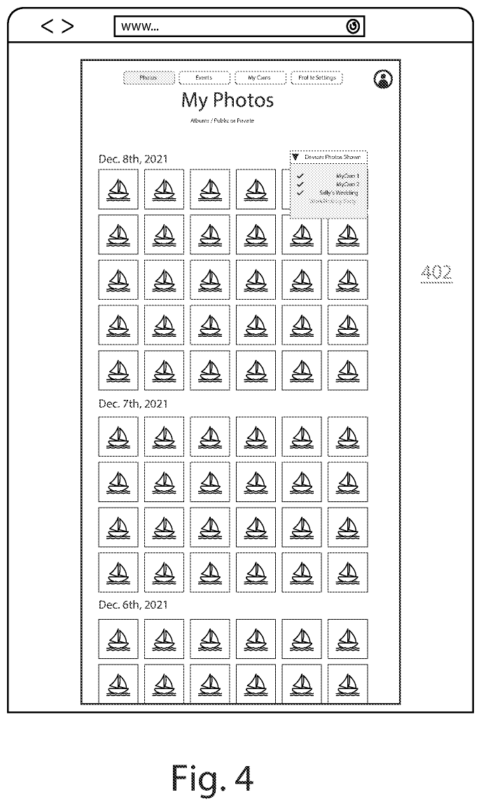

FIG. 4 illustrates an example internet browser screen display 402 for accessing media captured by the device described herein and transmitted to cloud storage. In an embodiment each media file (photos and video) captured by the device is automatically uploaded to the cloud for storage, organization, analysis and sharing. As noted previously, options for transmitting the data to the cloud include NB-IoT, cellular, wifi, and Bluetooth tethering. In the embodiment of FIG. 4, every media file that is captured is automatically streamed to the cloud where the files are stored, organized, and analyzed. This creates an unfiltered media feed (or “Photo Journal” or “Video Journal”) that is more emblematic of a user's life than any conventional service.

No captions are required, making the service easier to use. Photo collections online can be set to be public or private based on user preference.

Users are preferably assisted in finding media of interest in their account through auto-parsing based on media file data. Basic artificial intelligence techniques may be applied to analyze images and video uploaded to the cloud, cataloging information about the user, the images, and capture methods and behaviors.

Artificial Intelligence can be applied to a user's photo stream to analyze their photography habits based on the photos taken throughout the day/week/month/year. In an embodiment, the server determines an evolving “photographer profile” so users can learn about themselves and their behaviors. Information provided in the profile may include, for example, what times of day the user typically shoots, colors that most attract the user, most frequent subjects, and their preferred weather for photography.

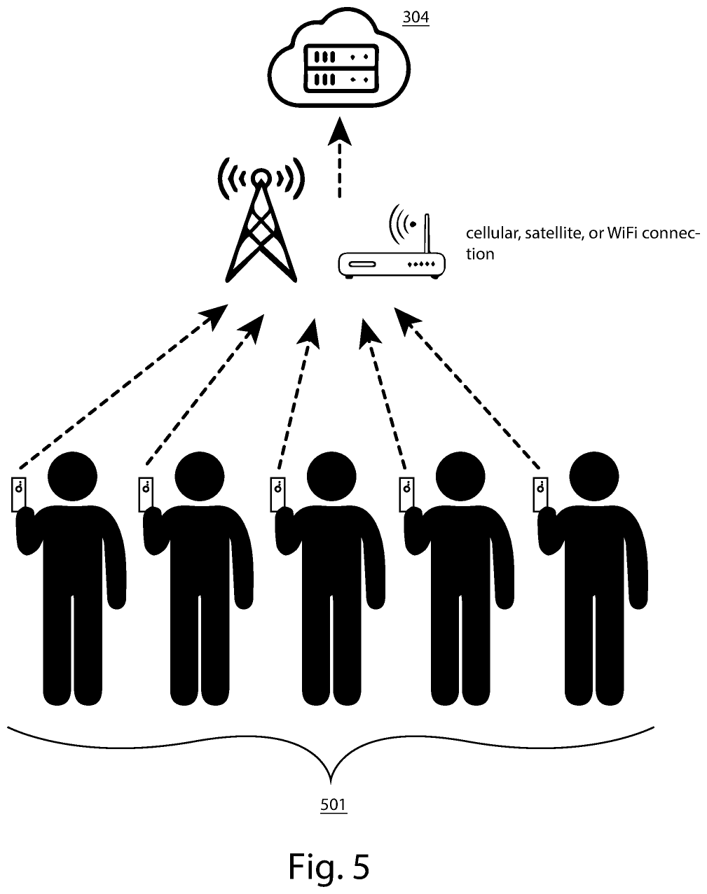

FIG. 5 illustrates a process wherein a plurality of camera devices, operated by different users 501, are deployed to wirelessly transmit media files and aggregate them in a single cloud storage account. Media files are transmitted by a cellular, IoT, Wifi, or satellite link. Typically, the same wireless uplink method will be used for all devices at an event location, but different wireless transmission methods can be used for particular devices if desired. To implement this process, a set of devices is programmed to contribute to the same photo-feed. The devices can then be distributed at weddings, parties, live events, political rallies, etc. The low cost of the device makes it possible to hand out a significant number of devices to enhance group enjoyment and save event memories photographically, without concern that loss of or damage to devices will create a hardship or financial loss. The images each user 501 captures are preferably shared immediately to a single online account, which can be viewed in real time by the group or used to generate slideshows, printed albums, and video collections. A user registration or camera ID number indicating the user/device that captured a media file can be recorded, or the system can be set so identification of the user 501 and the camera used are not recorded, making submissions anonymous.

Multiple devices can be linked together allowing groups of users to capture together and upload to shared accounts/media-feeds. Devices can be given out to be used in selected geographic areas or dispersed globally. The devices can also be decorated, branded, personalized, or skinned through various methods (sticker, shrink wrap, custom molds, etc.) to customize their appearance to fit any occasion or preference.

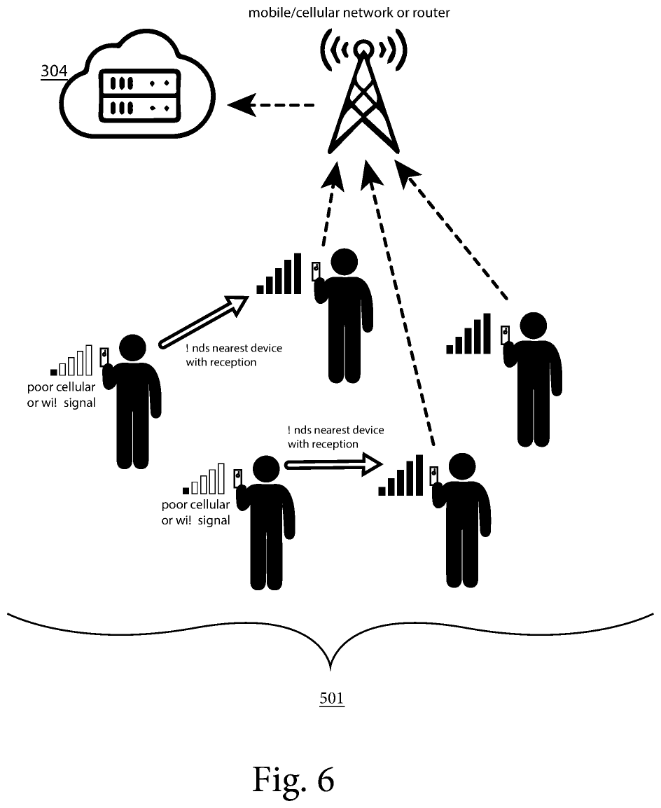

FIG. 6 illustrates a further embodiment with distributed group connectivity provided within a set of devices. In this embodiment, when used in a group and linked together via administrative preference, the devices will look for other nearby linked devices that have connectivity and are part of the group, if direct network connectivity is not available. In circumstances where a device cannot connect but can reach a nearby device that is connected, the device will relay media files to cloud storage through the nearby device that has a connection. This feature will increase effective connectivity range of devices and assure successful upload of data.

In addition, when several devices are used together in a particular setting they can use location triangulation determined by proximity of other devices to create a more accurate representation of the geographic position where a photo was taken in a space. This information can be used for location-based visualizations of media within a venue or other physical space.

In an embodiment, when multiple linked devices upload media, the media will be timestamped, allowing for the chronological organization on a timeline. Administrators can set time-constrained subsections in the timeline that will automatically further organize media. This will create a linear media narrative, with subsections in the form of “acts,” as an event or experience unfolds.

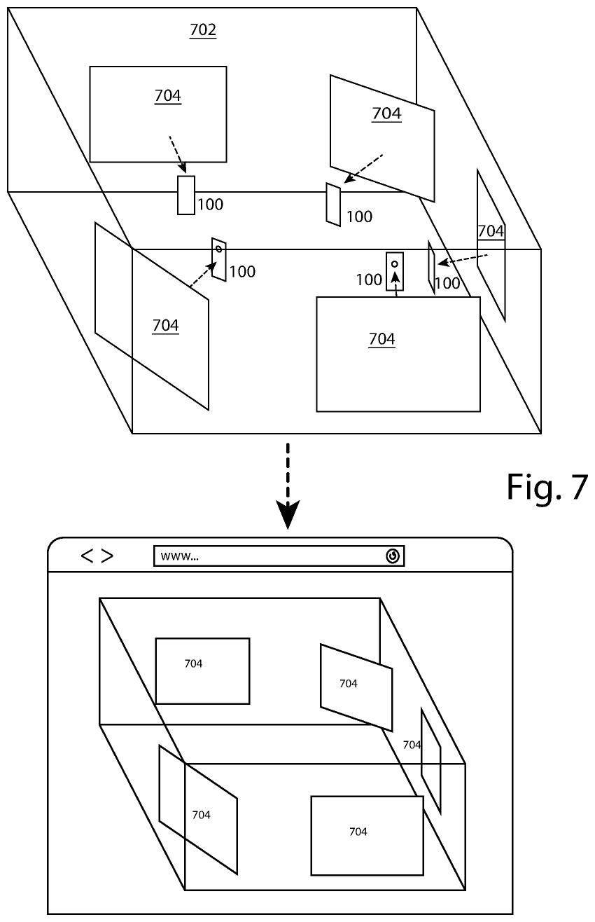

FIG. 7 illustrates an embodiment where a plurality of images 704 captured by one or more devices 100 in a defined area 702 are used to generate an interior photo mapping of a space. Photos captured by the devices in a defined area are overlaid on a map of the physical space using different pieces of captured data such as triangulation (detected through Bluetooth, Wi-Fi), geolocation (via cellular triangulation and GPS) proximity, accelerometer, photographic data, etc. If multiple devices 100 are used to capture images 704, they will collectively capture a representation of physical space 702 that can be assembled by the server receiving images from the devices. More particularly, the server can assemble a representation of physical space 702 at different moments in time, each from many different vantage points. These spatially oriented photos/videos can then be used to recreate physical space 702 virtually and over time.

In an embodiment, linked devices can receive direct and secure media (images and videos) from other linked devices without having to go through an ISP or mediating router.

In an embodiment, there are several modes for media capture and upload to the cloud:
automatic—automatically send images/video to the cloud after capture.
active—requires a user to intentionally upload to the cloud after capturing photo/video.
Time-interval—this will capture images at set time intervals and automatically upload them to the cloud, for uses such as on-the-go surveillance and security as well as other time-lapse applications.
motion capture—device will capture and upload when certain motion or sound is detected.

In an embodiment, the device can be configured as an anonymous media capture and sharing solution. Users can control whether personal information is stored natively. In the anonymous mode, no personal information is stored natively on the device. Images and videos are captured, uploaded, and shared to the cloud without any personal information or trackable data attached.

In an example embodiment, the device is provided with automatic erasing capabilities. Users may set parameters to completely delete all user generated data from the device if certain triggers occur. Examples of reset triggers include:
Time—timer and set time and date.
Lack of usage time lapse.
Remote ping to device.
Fall detection.
Emergency pattern on input mechanism on device.
Proximity from designated device (Wi-Fi, computer, other device).
Device enters a particular geographic location.

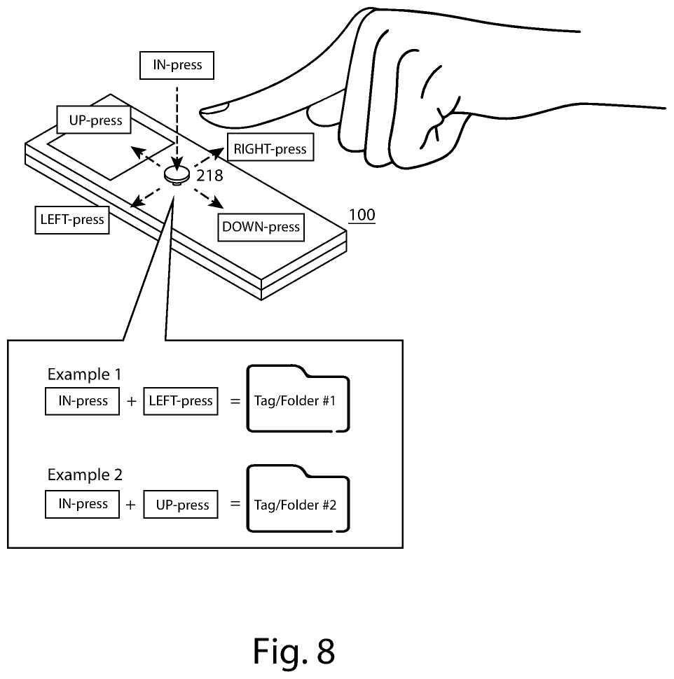

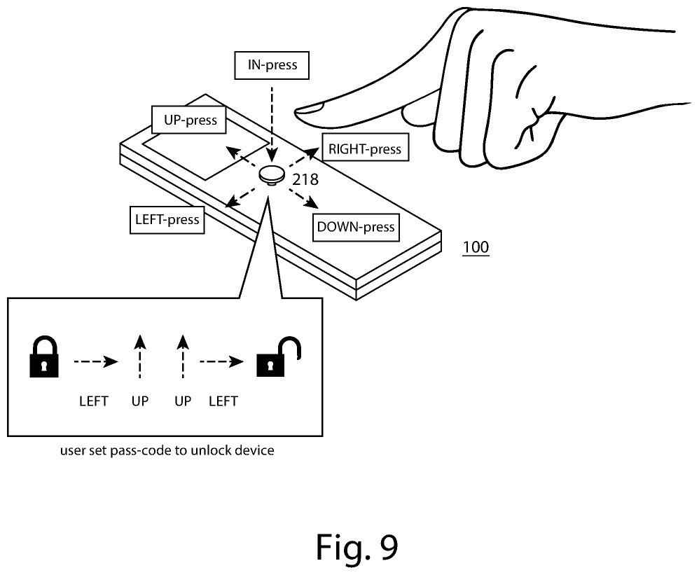

FIGS. 8 and 9 together illustrate a preferred implementation of a user input and control mechanism for the device. As shown in FIG. 8, a 5-position joystick 218 has a central “rest” position and four other input positions (up, down, left, and right). The joystick also has a switch activated by pressing the joystick in the direction of the housing surface (“IN”). With five lateral positions and two switch positions, there are a total of 10 control states into which the joystick can be placed by the user.

To capture an image or start capturing a video, the user will press IN on the joystick 218 (to capture) and then in any four directions on joystick to auto-tag content as it is captured. In this method of operation, the “IN press” captures the image and then seamlessly while still pressing IN, the user can press UP, DOWN, LEFT, or RIGHT on the joystick 218 to tag the captured photo or video with a user-defined tag. This motion can be accomplished with an “IN press” then seamless transition to a different direction OR with a slight pause and release between the IN press and the tag directions. Other methods of control are possible within the scope of the invention disclosed herein, but the inventor has found that this input method is particularly comfortable and convenient for the user when operation device 100.

FIG. 9 shows the use of joystick 218 to unlock device 100 for use. In an embodiment, device 100 can be locked and unlocked for usage via a pattern entered on joystick 218. The desired “unlock” pattern can be initially set using the joystick 218 and the device later unlocked by moving joystick 218 to repeat the unlock pattern. In an alternative embodiment (not illustrated in FIG. 9), device 100 is unlocked by shaking it in a set pattern as detected by the accelerometer. If a user decides to lock the device, the device will remain locked, and features will not be accessible unless the correct pattern is entered.

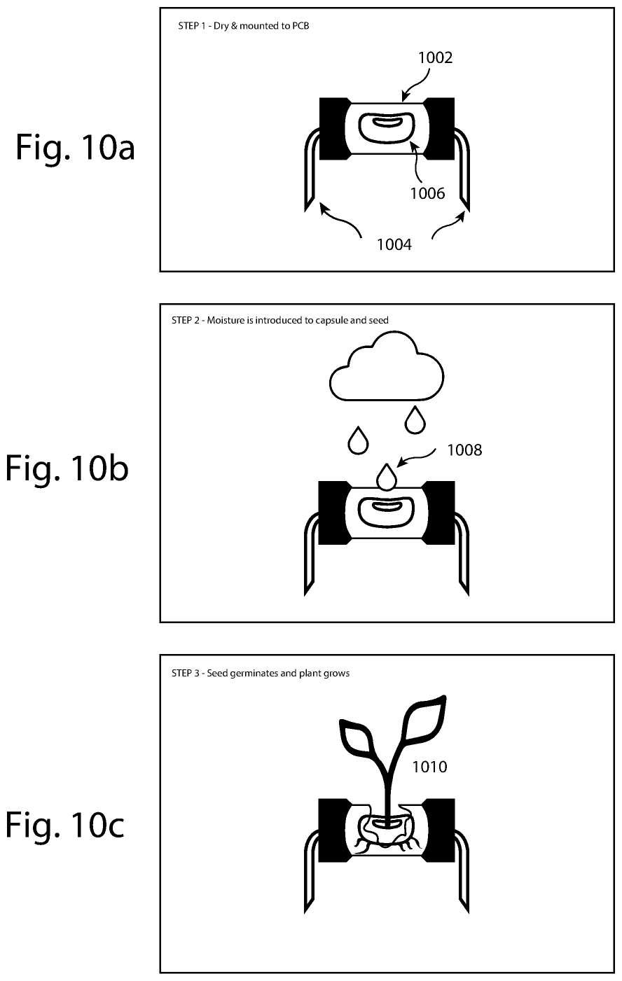

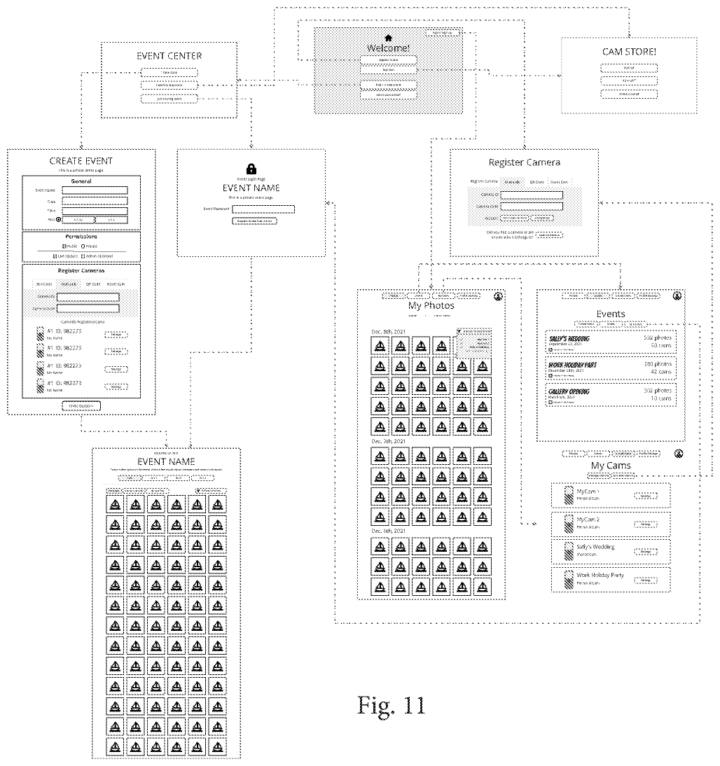

In an optional embodiment illustrated with reference to FIGS. 10a, 10b, and 10c, A seedpod 1002 comprises a moisture-dissolvable capsule (such as gelatin or non-gelatin material) containing a seed 1006 that will germinate if exposed to moisture 1008 over a certain period of time. In the embodiment of FIG. 10a, the seedpod 1002 is mounted to the circuit board of a device by leads 1004. The device in which the seedpod 1002 is installed may be device 100 described in this disclosure, or any other type of electronic device or another object that may be exposed to moisture when it is lost or discarded.

As shown in FIG. 10b, if moisture reaches the pod 1002, either through an access hole or via the device enclosure itself, a plant will be grown (shown in FIG. 10c) and the enclosure of the device will serve to protect it as the plant matures. If the device is lost or mistakenly improperly disposed of, this feature will contribute in a small way to the environment. This feature could also eventually lead to the retrieval of the device through the growth of a unique and noticeable plant in an unexpected location. In an embodiment, a “Germination Mode” can be set that would employ electricity from an attached battery to stimulate growth.

FIG. 11 is an illustration showing an embodiment of a menu system and operating functions of cloud server software adapted to support the registration, control, and operation of the camera devices of the present invention. The server software preferably implements the functions and operations described throughout this specification and is preferably accessible over the Internet using a standard HTML browser interface. As shown in FIG. 11, in this embodiment, the cloud software allows users to purchase cameras, register cameras, and set up an event where one or more cameras will be used to capture media files. The cloud software also allows users to review media files (which may be video files, image files, or both) that have been uploaded by the user's camera or cameras, and media files that were uploaded by other cameras linked to events in which the user participates.

In embodiments of the invention disclosed herein, central servers for receiving, collecting, and providing access to media files received from portable camera devices may include and be controlled by one or more processors. Electronic controls for these servers may be implemented in hardware, firmware, software, or any combination thereof. Embodiments of the server structure may also be implemented as instructions stored on a machine-readable medium, which may be read and executed by one or more processors, typically distributed in a network. A machine-readable medium may include any mechanism for storing or transmitting information in a form readable by a machine (e.g. a computing device). For example, a machine-readable medium may include read only memory (ROM); random access memory (RAM); hardware memory in handheld computers, tablets, smart phones, and other portable devices; magnetic disk storage media; optical storage media; flash memory devices; electrical, optical, acoustical, or other forms of propagated signals (e.g. carrier waves, infrared signals, digital signals, analog signals, etc.), Internet cloud storage, and others. Firmware, software, routines, instructions, may be described herein as performing certain actions. However, it should be appreciated that such descriptions are merely for convenience and that the functions described occur because computing devices, processors, controllers, or other devices are provided and execute firmware, software, routines, instructions, etc. to provide the operations described.

Although illustrative embodiments have been described herein in detail, it should be noted and understood that the descriptions and drawings have been provided for purposes of illustration only. Other variations both in form and detail can be added thereto without departing from the spirit and scope of the invention. The terms and expressions in this disclosure have been used as terms of description and not terms of limitation. Thus, the breadth and scope of the present invention should not be limited by any of the above-described exemplary embodiments but should be defined only in accordance with the claims and their equivalents. The terms and expressions herein should not be interpreted to exclude any equivalents of features shown and described, or portions thereof.

I claim:

1. A system for recording digital images, transmitting the images over a wireless network, and storing the images, comprising:
a. a plurality of portable digital cameras, each including an image sensor, a digital image data processing circuit connected to the image sensor, a memory element operably connected to the processing circuit to store digital image data, and a wireless transceiver operably connected to the processing circuit to transmit image data to the wireless network; and
b. at least one server connected to a communications network;
c. wherein said plurality of cameras are designated in said server as linked to at least one of a group of users and an event, such that the server receives image data from said plurality of linked cameras via the communications network and merges said image data from said plurality of linked cameras into a common account, whereby at least one person authorized to access said common account can access and view a collection of image data received from said plurality of linked cameras.

2. The system of claim 1, wherein said digital cameras collect video image data and said video image data is transmitted to the server and merged into said common account.

3. The system of claim 1, wherein the processing circuit in each camera further includes a data compression function, and the image data is compressed prior to transmission via the wireless network and reception by the server.

4. The system of claim 3, wherein the wireless transceiver is a narrow band Internet of Things transceiver.

5. The system of claim 3, wherein the wireless transceiver is one of a Wi-Fi transceiver, a Bluetooth transceiver, and a cellular data transceiver.

6. The system of claim 1, wherein the server further comprises an internet browser interface that allows the person authorized to access said account to register said plurality of cameras to be used by a plurality of operators to capture images at said event and merge said images into said account to memorialize said event.

7. The system of claim 6, wherein said plurality of operators capture a plurality of images at a location and said server receives said plurality of images and combines data from said plurality of images to generate an interior photo mapping of said location.
